(19) United States
(12) Patent Application Publication
(10) Pub. No.: US 2020/0029246 A1
(43) Pub. Date: Jan. 23, 2020

(54) SEPARATION OF RADIO CHAINS BETWEEN MISSION-CRITICAL DEVICES AND ENTERPRISE CLIENTS

(71) Applicant: Hewlett Packard Enterprise Development LP, Houston, TX (US)

(72) Inventors: Subbiah Nagarajan Veerabudran, San Jose, CA (US); Mohd Shahnawaz Siraj, San Jose, CA (US)

(21) Appl. No.: 16/041,715

(22) Filed: Jul. 20, 2018

(51) Int. Cl. H04W 28/16; H04B 7/0452

(52) U.S. Cl. CPC H04W 28/16; H04W 88/10; H04B 7/0452

(57) ABSTRACT

Systems and methods for separation of access point radio chains between mission-critical devices and enterprise clients include grouping the radio chains to form a plurality of logical radios; assigning, to a first frequency channel of the access point, a first one of the logical radios; assigning, to a second frequency channel of the access point, a second one of the logical radios; the first frequency channel occupying a different frequency band than the second frequency channel; exchanging high-quality-of-service (QoS) data with one or more high-QoS devices over the first logical radio; and exchanging low-QoS data with one or more low-QoS devices over the second logical radio.

### DESCRIPTION OF RELATED ART

People increasingly rely upon computer networks to perform everyday tasks for business and pleasure, using a variety of devices. The importance of these tasks spans a range from the casual to the mission-critical. The importance of these tasks is reflected by the corresponding performance requirements placed upon the computer networks employed, and may be described by the Quality of Service (QoS) required of each network connection. This QoS may comprise a number of performance parameters including throughput, latency, packet loss, bit rate, availability, jitter, and the like.

Computer networks generally implement QoS requirements through traffic prioritization and resource reservation control mechanisms, providing different priorities to different applications, users, or data flows. For example, a user of a File Transport Protocol (FTP) server generally requires delivery of a very large amount of data but will not be concerned if a few seconds elapse between the request for the data and the start of the data delivery. Conversely, a user of a gaming console requires very quick interactions so game play proceeds smoothly, but does not require transport of very large data files. While both devices have high QoS requirements and so may be referred to as high-QoS devices, the devices have very different QoS requirements. The FTP server requires very high throughput, while the gaming console requires very low latency.

In contrast to these high-QoS devices, enterprise clients such as laptops and smartphones generally have lower QoS requirements, and may be referred to as low-QoS devices. Users of these low-QoS devices are generally involved in low-QoS tasks such as word processing and email exchange, and so do not have stringent requirements for latency, throughput, and the like.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates one example of a network configuration that may be implemented for an organization, such as a business, educational institution, governmental entity, healthcare facility or other organization.

FIG. 2 shows a prior art 8×8 access point.

FIG. 3 shows a prior art radio chain.

FIG. 4 shows a prior art wireless communications system including the prior art access point of FIG. 2 where the radio chains have been grouped into two 4×4 logical radios.

FIG. 5 shows a wireless communications system according to one embodiment.

FIG. 6 is a block diagram of an example computing component or device for separating radio chains between mission-critical devices and enterprise clients in accordance with one embodiment.

FIG. 7 depicts a block diagram of an example computer system in which various of the embodiments described herein may be implemented.

The figures are not exhaustive and do not limit the present disclosure to the precise form disclosed.

### DETAILED DESCRIPTION

Until now, mission-critical high-QoS devices have been connected to computer networks using wired connections that can easily accommodate their high QoS requirements. For example Ethernet connections are commonly employed. But for ease of deployment, information technology managers would like to migrate these high-QoS devices to wireless connections. But sharing an access point (AP) with both high-QoS devices and low-QoS devices will adversely affect QoS for the high-QoS devices. Thus until now the only wireless solution available was to employ a dedicated AP for each high-QoS device. The cost of this solution is considered prohibitive.

Implementations of the disclosed technology may include systems and methods that divide a multi-stream AP into multiple multi-stream logical radios on different frequency channels, as permitted by the new 802.11ax amendment. The logical radios are assigned to devices based on QoS, with high-QoS devices being assigned to one logical radio and low-QoS devices being assigned to the another logical radio. For example the radio chains of one logical radio may be dedicated to high-throughput or low-latency devices while reserving the radio chains of another logical radio for enterprise clients. The radios of the high-QoS critical devices may be implemented as multi-stream radios. For example an 8×8 radio may be split into two 4×4 logical radios with one dedicated to two 2×2 FTP servers and the other serving a multitude of smartphones and laptops. Latency-sensitive devices may be scheduled using an orthogonal frequency-division multiple access (OFDMA) scheme, while high-throughput devices may be scheduled with a multi-user, multiple input, multiple output (MU-MIMO) scheme. To prevent enterprise clients from using the dedicated logical radio, the service set identifiers (SSIDs) of that logical radio may be concealed.

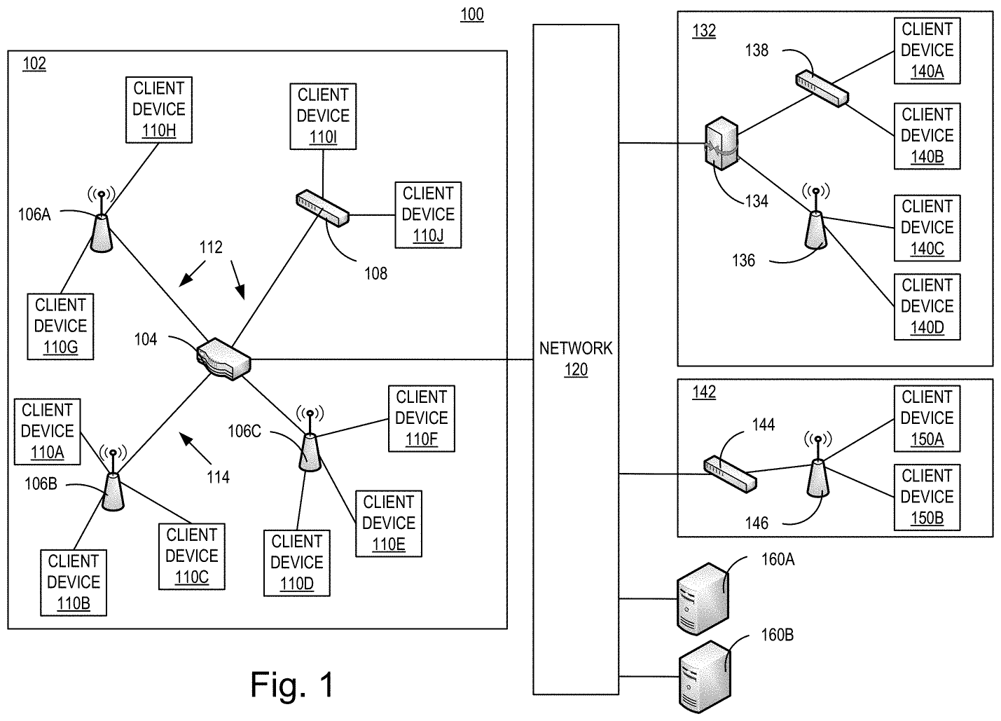

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. This diagram illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which can be, for example, an office network, home network or other network installation. The primary site 102 network may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a controller 104 in communication with the network 120. The controller 104 may provide communication with the network 120 for the primary site 102, though it may not be the only point of communication with the network 120 for the primary site 102. A single controller 104 is illustrated, though the primary site may include multiple controllers and/or multiple communication points with network 120. In some embodiments, the controller 104 communicates with the network 120 through a router (not illustrated). In other embodiments, the controller 104 provides router functionality to the devices in the primary site 102.

A controller 104 may be operable to configure and manage network devices, such as at the primary site 102, and may also manage network devices at the remote sites 132, 134. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless Access Points (APs) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the illustrated example, APs 106a-c can be managed and configured by the controller 104. APs 106a-c communicate with the controller 104 and the network over connections 112, which may be either wired or wireless interfaces.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities.

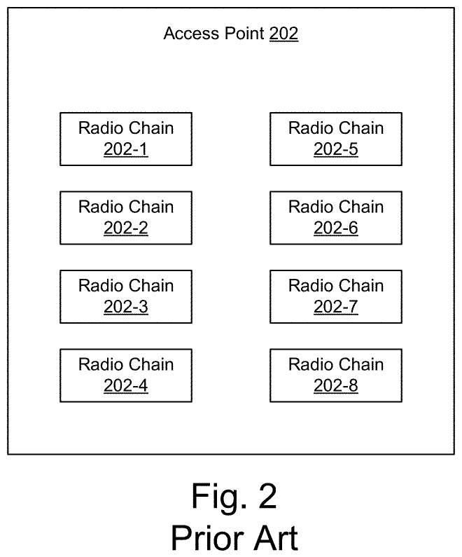

FIG. 2 shows a prior art 8×8 access point 200. The access point 200 is referred to as “8×8” because it supports up to eight streams of data and up to eight users. The 8×8 access point 200 includes eight radio chains 202-1 through 202-8.

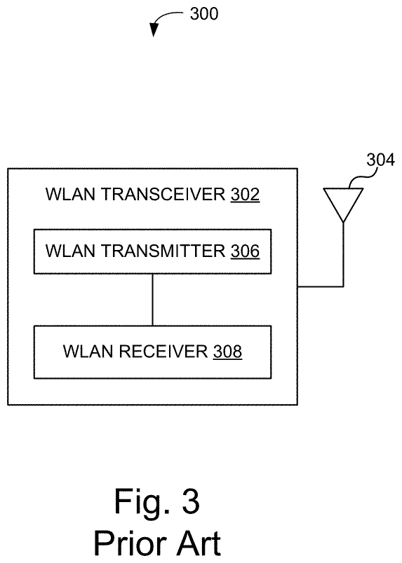

FIG. 3 shows a prior art radio chain 300. The radio chain 300 includes a wireless local-area network (WLAN) transceiver 302 and an antenna 304. The WLAN transceiver 302 includes a WLAN transmitter 306 and a WLAN receiver 308.

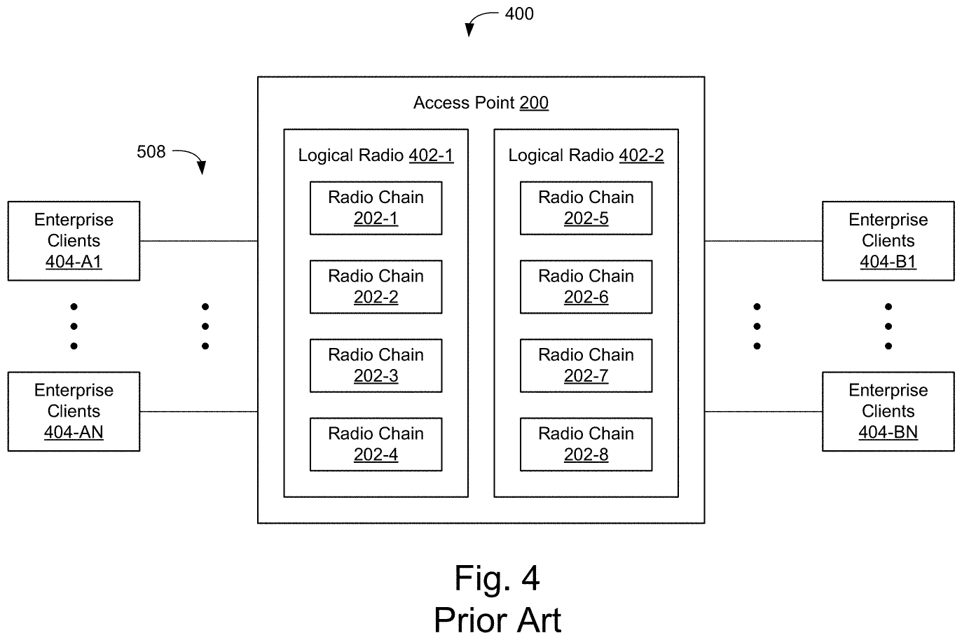

The new 802.11ax amendment allows the radio chains of multi-stream access point to be grouped into multiple logical radios. FIG. 4 shows a prior art wireless communications system 400 including the prior art access point 200 of FIG. 2 where the radio chains 202 have been grouped into two 4×4 logical radios 402-1 and 402-2. In FIG. 4, four radio chains 202-1 through 202-4 have been grouped to form the logical radio 402-1, and the other four radio chains 202-5 through 202-8 have been grouped to form the other logical radio 402-2. Each logical radio 402 may communicate with a separate group of wireless clients 404. In Figure 4, logical radio 402-1 communicates with a first set of M enterprise clients 404-A1 through 404-AM, and logical radio 402-2 communicates with a second set of N enterprise clients 404-B1 through 404-BN.

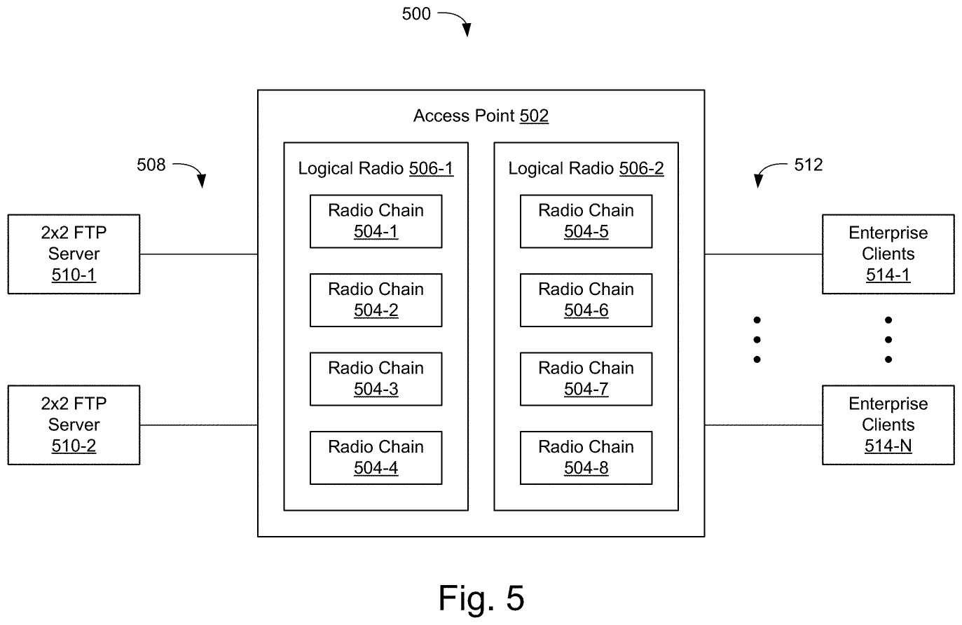

FIG. 5 shows a wireless communications system 500 according to one embodiment. The wireless communications system 500 includes an 8×8 access point 502. While the disclosed technology is described in terms of an 8×8 access point, it should be understood that the disclosed technology applies to access points of other dimensions as well.

The 8×8 access point 500 includes eight radio chains 504-1 through 504-8. The radio chains 504 have been grouped to form two 4×4 logical radios 506-1 and 506-2. In FIG. 5, four radio chains 504-1 through 504-4 have been grouped to form one 4×4 logical radio 506-1, and the other four radio chains 504-5 through 504-8 have been grouped to form the other 4×4 logical radio 506-2. While the disclosed technology is described in terms of dividing an 8×8 access point into two 4×4 logical radios, it should be understood that the disclosed technology applies to divisions into logical radios of other dimensions as well.

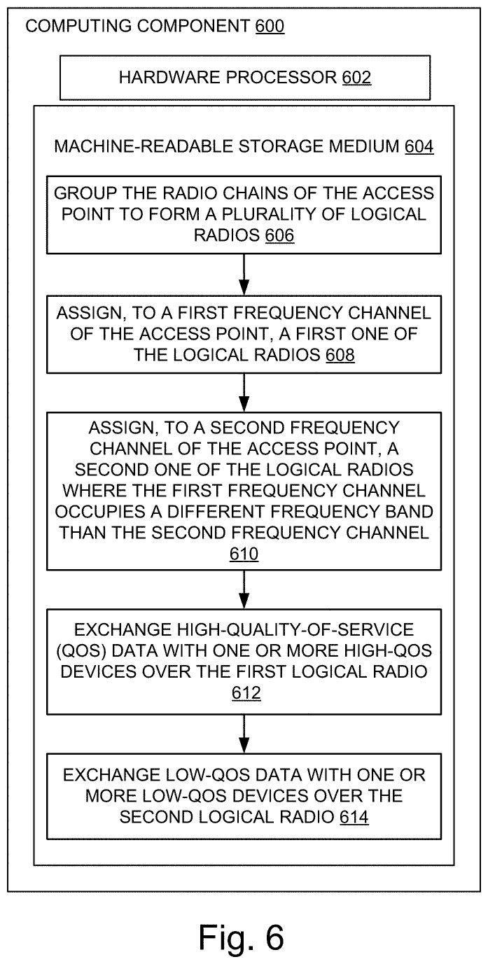

FIG. 6 is a block diagram of an example computing component or device 600 for separating radio chains between mission-critical devices and enterprise clients in accordance with one embodiment. Computing component 600 may be, for example, a server computer, a controller, or any other similar computing component capable of processing data. In the example implementation of FIG. 6, the computing component 600 includes a hardware processor, 602, and machine-readable storage medium, 604. In some embodiments, computing component 600 may be an embodiment of an AP or AP controller, e.g., AP 502, respectively, or a component of network 120 of FIG. 1, for example. More particularly, computing component 600 may be a component of a central entity such as wireless mobility controller in the network.

Hardware processor 602 may be one or more central processing units (CPUs), semiconductor-based microprocessors, and/or other hardware devices suitable for retrieval and execution of instructions stored in machine-readable storage medium, 604. Hardware processor 602 may fetch, decode, and execute instructions, such as instructions 606-612, to control processes or operations for generating and transmitting the composite radio signal 330. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 602 may be a non-transitory storage medium, where the term “non-transitory” does not encompass transitory propagating signals. As described in detail below, machine-readable storage medium 602 may be encoded with executable instructions, for example, instructions 606-612.

Hardware processor 602 may execute instruction 606 to group the radio chains 504 of the access point 502 to form a plurality of logical radios. In the example of FIG. 5, the eight radio chains 504 of the 8×8 access point 502 are grouped to form two 4×4 logical radios.

Hardware processor 602 may execute instruction 608 to assign, to a first frequency channel of the access point 502, a first one 506-1 of the logical radios 506.

Hardware processor 602 may execute instruction 610 to assign, to a second frequency channel of the access point 502, a second one 506-2 of the logical radios 506 where the first frequency channel occupies a different frequency band than the second frequency channel.

Hardware processor 602 may execute instruction 612 to exchange high-quality-of-service (QoS) data with one or more high-QoS devices over the first logical radio 506-1. In the example of FIG. 5, the logical radio 506-1 exchanges high-throughput data 508 with two 2×2 FTP servers 510-1 and 510-2. Because the QoS required by the FTP servers 510 is high throughput, the FTP data 508 may be scheduled with a multi-user, multiple input, multiple output (MU-MIMO) scheme. With data having other QoS requirements, other scheduling mechanisms may be employed to optimize QoS. For example the QoS required by gaming applications is low latency, and therefore the gaming data may be scheduled using an orthogonal frequency-division multiple access (OFDMA) scheme.

Hardware processor 602 may execute instruction 614 to exchange low-QoS data with one or more low-QoS devices over the second logical radio 506-2. In the example of FIG. 5, the logical radio 506-2 exchanges data 512 with N enterprise clients 514-1 through 514-N. To prevent the enterprise clients 514 from exchanging data with the high-QoS logical radio 506-1, the service set identifier (SSID) for that logical radio 506-1 is concealed. For example, the access point 502 may not broadcast the SSID for the logical radio 506-1. But to enable the enterprise clients 514 to easily exchange data with the low-QoS logical radio 506-2, the access point 502 may broadcast the SSID for that logical radio 506-2.

Implementing embodiments of the disclosed technology provides several advantages. Access points implemented according to these embodiments provide a solution that can provide backhaul connections as well as replace fat pipes for entities that require high-throughput, low-latency connections. This would eliminate the need for expensive wiring through buildings for such devices, providing significant cost reductions in construction, deployment and maintenance. For high-throughput requirements, these access points can allot larger resource units, allowing up to 1.2 gbs phy rate for 2-stream clients under IEEE 802.11ax. These embodiments also leverage existing enterprise-managed networks to provide high QoS where needed while servicing enterprise clients that are completely oblivious to this infrastructure.

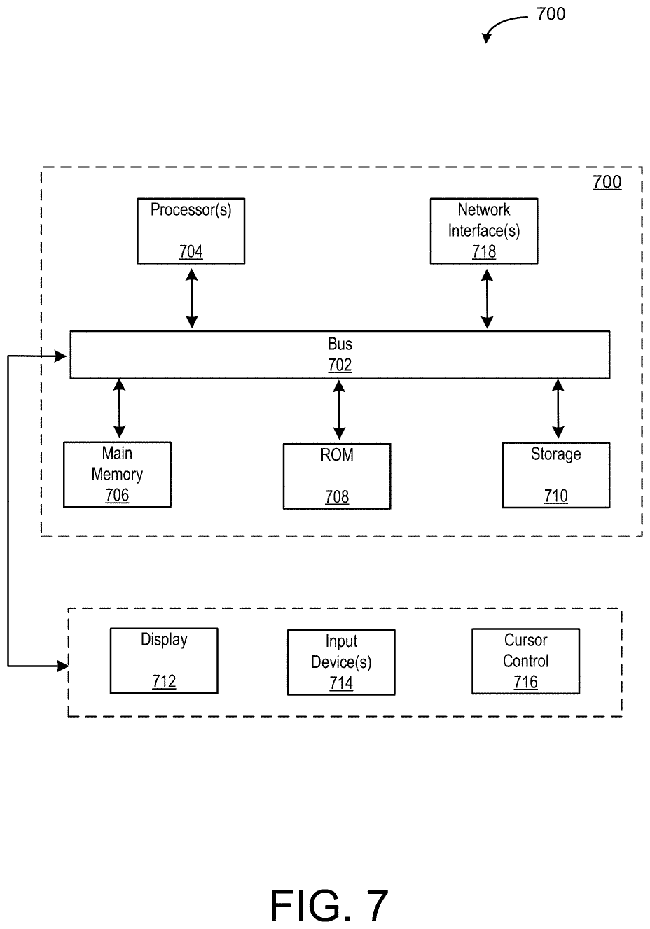

FIG. 7 depicts a block diagram of an example computer system 700 in which various of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

1. A non-transitory machine-readable storage medium encoded with instructions executable by a hardware processor of a computing component of an access point having a plurality of radio chains, the machine-readable storage medium comprising instructions to cause the hardware processor to:
group the radio chains of an access point to form a plurality of logical radios, wherein each radio chain includes a wireless local area network (WLAN) transceiver and antenna, and wherein the plurality of logical radios includes a first logical radio having a first service set identifier (SSID) to provide communications with a first quality of service (QoS) and a second logical radio having a second SSID to provide communications with a second QoS, the first QoS being a higher performance standard than the second QoS;
assign, to a first frequency channel of the access point, the first logical radio;
assign, to a second frequency channel of the access point, the second logical radio, wherein the first frequency channel occupies a different frequency band than the second frequency channel;
conceal the first SSID of the first logical radio and broadcast the second SSID of the second logical radio;
exchange a first set of data at the first QoS with one or more high-QoS devices over the first logical radio; and
exchange a second set of data at the second QoS with one or more low-QoS devices over the second logical radio.

2. The non-transitory machine-readable storage medium of claim 1, the instructions further causing the hardware processor to:
schedule the first set of data with a multi-user, multiple input, multiple output (MU-MIMO) scheme;
wherein the one or more high-QoS devices require high throughput.

3. The non-transitory machine-readable storage medium of claim 1, the instructions further causing the hardware processor to:
schedule the first set of data with an orthogonal frequency-division multiple access (OFDMA) scheme;
wherein the one or more high-QoS devices require low latency.

4. (canceled)

5. The non-transitory machine-readable storage medium of claim 1, wherein:
the access point conforms to IEEE 802.11ax.

6. A method for an access point having a plurality of radio chains, the method comprising:
grouping the radio chains of the access point to form a plurality of logical radios, wherein each radio chain includes a wireless local area network (WLAN) transceiver and antenna, and wherein the plurality of logical radios includes a first logical radio having a first service set identifier (SSID) to provide communications with a first quality of service (QoS) and a second logical radio having a second SSID to provide communications with a second QoS, the first QoS being a higher performance standard than the second QoS;
assigning, to a first frequency channel of the access point, the first logical radio;
assigning, to a second frequency channel of the access point, the second logical; radio, wherein the first frequency channel occupies a different frequency band than the second frequency channel;
concealing the first SSID of the first logical radio and broadcasting the second SSID of the second logical radio;
exchanging a first set of data at the first QoS with one or more high-QoS devices over the first logical radio; and
exchanging a second set of data at the second QoS with one or more low-QoS devices over the second logical radio.

7. The method of claim 6, further comprising:
scheduling the first set of data with a multi-user, multiple input, multiple output (MU-MIMO) scheme;
wherein the one or more high-QoS devices requiring require high throughput.

8. The method of claim 6, further comprising:
scheduling the first set of data with an orthogonal frequency-division multiple access (OFDMA) scheme;
wherein the one or more high-QoS devices require low latency.

9. (canceled)

10. The method of claim 6, wherein:
the access point conforms to IEEE 802.11ax.

11. An access point comprising:
a plurality of radio chains;
a hardware processor; and
a non-transitory machine-readable storage medium encoded with instructions executable by the hardware processor to:
group the radio chains to form a plurality of logical radios, wherein each radio chain includes a wireless local area network (WLAN) transceiver and antenna, and wherein the plurality of logical radios includes a first logical radio having a first service set identifier (SSID) to provide communications with a first quality of service (QoS) and a second logical radio having a second SSID to provide communications with a second QoS, the first QoS being a higher performance standard than the second QoS;
assign, to a first frequency channel of the access point, the first logical radio;
assign, to a second frequency channel of the access point, the second logical radio, wherein the first frequency channel occupies a different frequency band than the second frequency channel;
conceal the first SSID of the first logical radio and broadcast the second SSID of the second logical radio;
exchange a first set of data at the first QoS with one or more high-QoS devices over the first logical radio; and
exchange a second set of data at the second QoS with one or more low-QoS devices over the second logical radio.

12. The access point of claim 11, the instructions further causing the hardware processor to:
schedule the first set of data with a multi-user, multiple input, multiple output (MU-MIMO) scheme;
wherein the one or more high-QoS devices requiring require high throughput.

13. The access point of claim 11, the instructions further causing the hardware processor to:
schedule the first set of data with an orthogonal frequency-division multiple access (OFDMA) scheme;
wherein the one or more high-QoS devices require low latency.

14. (canceled)

15. The access point of claim 11, wherein:
the access point conforms to IEEE 802.11ax.
